(19) United States
(12) Patent Application Publication
(10) Pub. No.: US 2003/0105621 A1
(43) Pub. Date: Jun. 5, 2003

(54) Method for computer-assisted translation

(76) Inventor: Philippe Mercier, Sterrebeek (BE)

Correspondence Address: James C. Wray, Suite 300, 1493 Chain Bridge Road, McLean, VA, 22101, US

(21) Appl. No.: 10/000,080

(22) Filed: Dec. 4, 2001

(51) Int. Cl. G06F 17/28

(52) U.S. Cl. 704/2

(57) ABSTRACT

Method for computer-assisted translation, by processing a source language sequence by means of translation software to provide a user with (a) target language translation sequence proposal(s) for said source language sequence, to allow said user to select and/or modify a target language translation sequence proposal, and to save the pair of submitted source language sequence and selected and/or modified target language translation sequence for future use, in which provides at least one user, operating a user computer, with simultaneous access, through a network, to one or more translation softwares located on one or more remote translation servers, and/or more than one users, operating distinct user computers, with simultaneous access, through a network, to at least one translation software located on at least one remote translation server.

### BACKGROUND OF THE INVENTION

1. Field of the Invention

The invention relates to improvements to methods for computer assisted translation, and more particularly to improvements to such translation methods in which a source language sequence (a sentence, word or group of words) is processed by means of translation software to provide a user with (a) target language translation sequence proposal(s) for said source language sequence, to allow said user to select and/or modify a target language translation sequence proposal, and to save the pair of submitted source language sequence and selected and/or modified target language translation sequence for future use.

2. State of the Art

The essence of such computer assisted translation methods is illustrated by FIG. 1.

Such methods are known per se, for instance from U.S. Pat. No. 4,706,212 and from international patent application WO 99/57651.

### SUMMARY OF THE INVENTION

It has been shown in practice that it is possible to provide improvements in the way of using such known translation methods. It is one object of the present invention to improve such methods by allowing more ready providing access to multiple translation software systems.

It is another object of the invention to improve the quality of such methods by allowing enhanced availability of providing pairs of submitted source language sequences and target language translation sequences and by allowing integration of multiple input sources

It is still another object of the invention to improve such methods by allowing several remotely located translators to work in an integrated and coordinated way on a common translation project.

Those objectives (illustrated by FIG. 4), as well as other advantages, can be achieved by a method for computer-assisted translation, in accordance with the present invention, which provides at least one user, operating a user computer, with simultaneous access, through a network, to at least one translation software located on one or more remote translation servers, and/or more than one users, operating distinct user computers, with simultaneous access, through a network, to at least one translation software located on at least one remote translation server.

According to this invention the translation software is preferably provided from the remote translation servers, as illustrated by FIG. 2.

According to this invention, the “translation server” can be any computer running a “translation software”, the results of which are made available by any means to another software running on the same or another computer.

According to a preferred feature of the invention, the method provides said users with access to one or more translation softwares operated on at least one remote translation server.

According to one specific embodiment of the invention the method can, preferably, provide access to several translation projects simultaneously whereas several users are provided with simultaneous access to one translation project.

According to another specific embodiment of the invention the method can provide access to several translation projects simultaneously, whereas a single translation project uses several translation softwares, and whereas several users are provided with simultaneous access to one translation project.

The user computer is preferably connected to the remote translation server(s) through an internet protocol network.

Preferred embodiments of the invention may comprise that the method operates a client server model through internet, preferably involving a communication server as referred to herebelow, or that the method operates a peer to peer model using a communication server.

According to a further feature of the invention the user computer is preferably connected to the remote translation server from a browser application or from a word processing application.

According to still another feature of the invention the translation software(s) is/are preferably selected from translation memory systems and/or machine translation systems or any other server or application that can be queried for translations.

According to still a further feature of the invention the translation software(s) can provide further information, in addition to the target language translation sequence proposal(s).

### DETAILED DESCRIPTION OF THE PREFERRED EMBODIMENTS

The method allows remote translation, for example over the Internet, from a browser or directly from Microsoft Word or any other word processor or application. The users (client computers) connect to a “Translation Server” and ask for the translation of a sentence, word or, group of words. The Translation Server answers with translation candidate(s) and possibly some other information (ie: % match of source sentence). Then the user can make modifications to the proposed translation (if any) and the new pair source/target (source sentences or words/target sentence or words) is sent back to the Translation Server for future use. The Translation Server can be located on a separate server or can reside on the translator machine.

The Translation Server operates a “Translation Software” which can consist of any translation software, for example commercially available systems, such as a translation memory system (ex: trados, sdlx, déjàvu, etc.), or a machine translation system (systran), or any other software or system (such as a web server) which can be or could be re-designed to be queried for translation. If a second program is running with the Translation Software (for example Multiterm run with TRADOS for terminology terms), this can be interfaced also. Both types of programs are known in this document as the “Translation Software”.

The method can for instance operate through the internet using a “client server model” (see FIG. 8) or a “peer to peer model” using a centralized server like napster (see FIG. 9).

The method according to the invention, may thus, very suitably, comprise one or more of the following preferred features, separately or in combination:

the user computer is connected to the remote translation server(s) through an internet protocol network or a LAN (Local Area Network) network;

the method operates a client server model through internet;

the method involves a communication server;

the method operates a peer to peer model using a communication server;

the user computer is connected to the remote translation server from a browser application or from a word processing application;

the translation software(s) is/are translation memory systems and/or machine translation systems and/or any application or server that can be queried for translation;

the translation software(s) provide further information, in addition to the target language translation sequence proposal (s);

the method operates several translation softwares, can operate several translation projects concomitantly and several users can connect concomitantly to one translation project;

the said several translation softwares are provided from a single translation server or from multiple translation servers;

several occurrences of one or more translation software(s) can run simultaneously on one Translation Server.

### BRIEF DESCRIPTION OF THE DRAWINGS

These preferred features of the invention, as well as other details of the invention are explained in more detail herebelow, in the description of specific embodiments of the invention, with reference to the accompanying drawings in which:

FIG. 1 illustrates the principle of a state of the art.

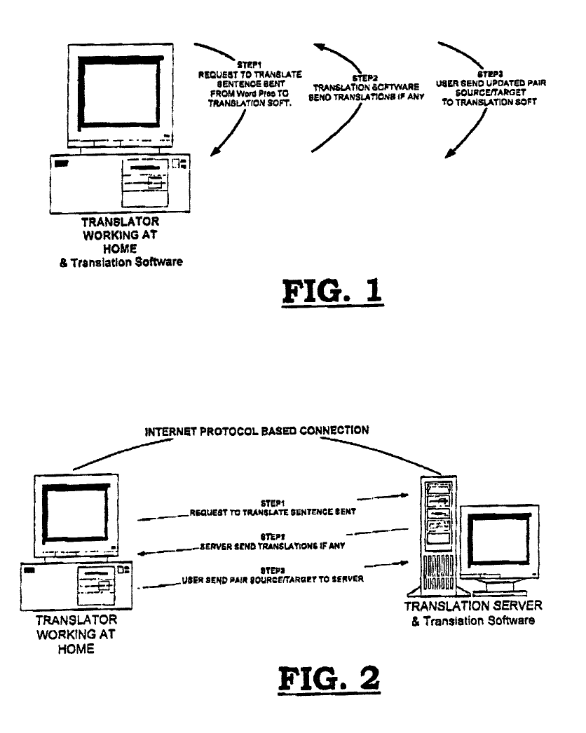

FIG. 2 illustrates the principle of the method according to the invention.

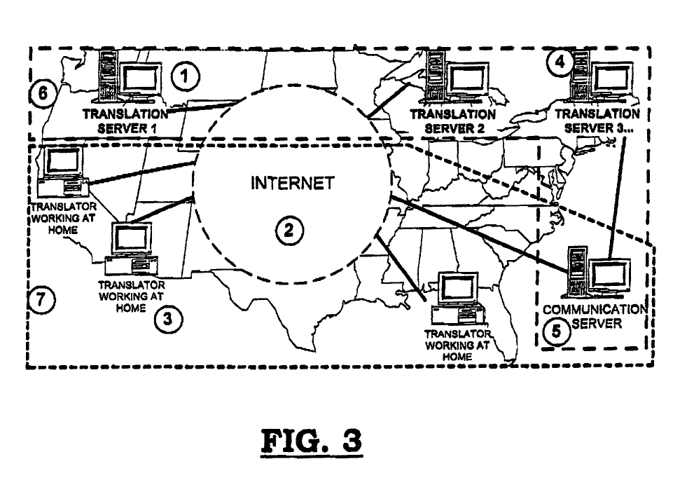

FIGS. 3 and 4 illustrate the organization of a specific embodiment of the method according to the invention.

FIG. 5 illustrates a preferred architecture of one specific embodiment of the method according to the invention.

FIGS. 6 and 7 illustrate examples of user screen embodiments of the method.

FIGS. 8 and 9 illustrate client/server and peer to peer embodiments of the method according to the invention.

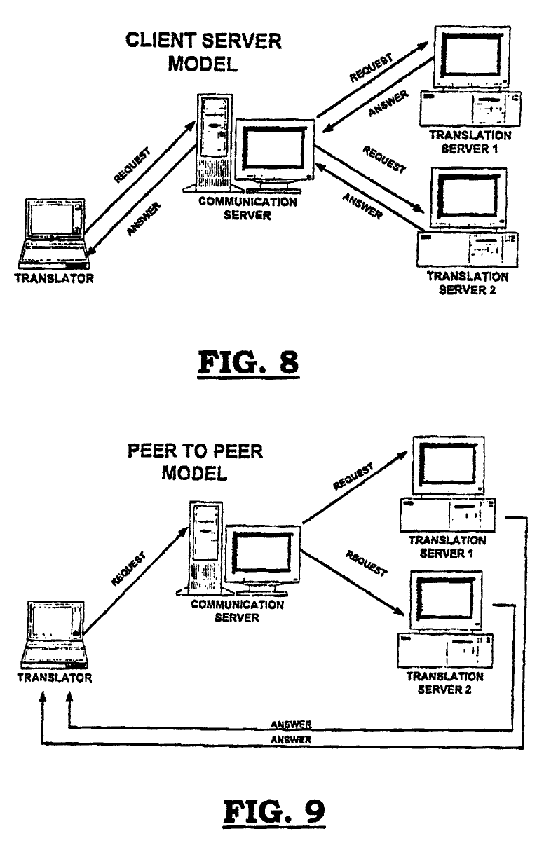

### DETAILED DESCRIPTION OF THE PREFERRED EMBODIMENTS

1. Organization of Specific Embodiment of the Method According to the Invention.

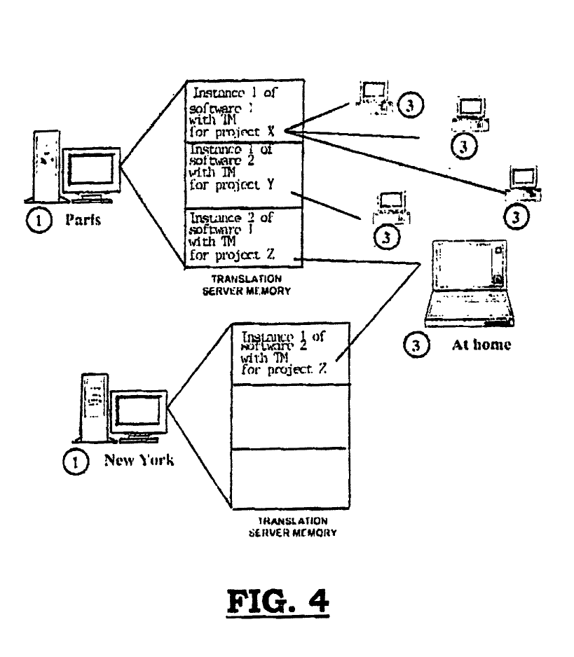

The general principle of the invention is illustrated by FIG. 3 having reference to a specific embodiment of the method as shown in FIG. 4.

1.1 Network Organization

All the computers using the system translation servers (1),(4), “translators working at home” (3), and the communication server (5)) can be local or connected remotely through internet (2). Every computer in the system can be at a different location.

Note: “Translator working at home” can be any client computer located anywhere (“at home” is an example).

Three zones of computers are defined:

the client zone

the server zone

the intersection zone

Note: The “zones” are virtual zones. Any computer of each zone can be located anywhere in the world.

1.1.1 The Client Zone (7)

The client computers—“Translator working at home” computers (3)—are in the client zone (7).

1.1.2 The Server Zone (6)

In this embodiment of the method according to the invention, the system is based on a multiserver architecture.

The server zone (6) contains one or several TRANSLATION SERVERS (1), (4) connected to internet (1) and/or locally (4). The Translation Servers (1) & (4) run one or multiple Translation Software(s). A Translation Software is a Translation memory program, a machine translation program or any other software or system (e.g.: web server) that can be queried for Translations.

1.1.3 Intersection Zone (5)

The intersection of the client and server zones contain the COMMUNICATION SERVER. R (5). In this embodiment of the method, the computers within the CLIENT ZONE (7) can communicate with the TRANSLATION SERVERS (1), (4) in the SERVER ZONE (6), through the COMMUNICATION SERVER.

1.2 Working of the Method.

When operating the method according to this embodiment of the invention, the translator (3)—or any user using the method—, working on a computer at home (or anywhere else), has MS-Word (or any other word processor or application) as interface for the text to translate. He should first connect to the Communication Server using an identifier of the server (e.g: IP address), a credential (e.g: user name), a verifier (e.g: a password) and the project reference.

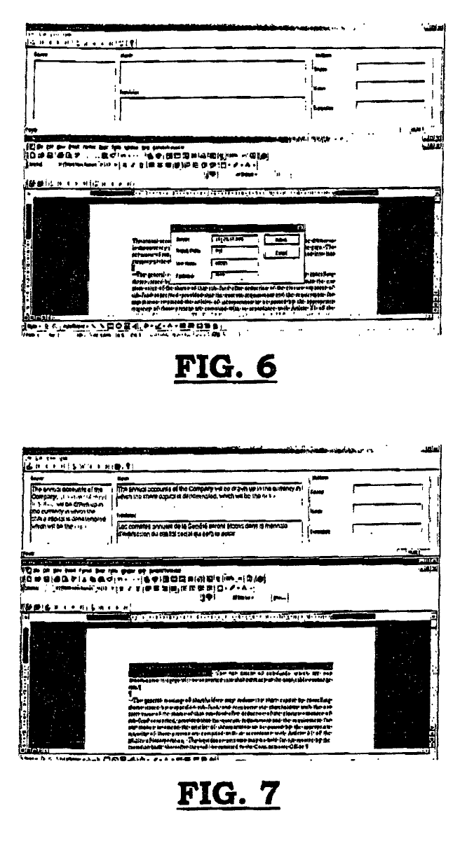

This is illustrated by the examples of user screen represented in FIG. 6.

The user can then start requesting translations. The remote interface application will display some of the information coming from the server (ex: if there is a word difference between the source sentence and the sentence found on the server, that difference will be highlighted in that application).

This is illustrated by the examples of user screen represented in FIG. 7.

1.3 Translation Server's Organization of a Specific Embodiment of the Invention.

Regarding the Translation Server's organization, it is important to note that, in this embodiment of the method according to the invention, one or more users (3) in the client (7) zone can be connected to one project, and one project can be connected to several instances of a Translation Software. The instances of the Translation Software can be from different software publishers. Several instances on the Translation Software can run on one single machine, and/or each instance of the translation softwares can run on separate computers (even if they are used for one project).

This is illustrated in FIG. 4.

In the illustrated example we see that Translator 1, working on a laptop computer, can use (read & update) at the same time two different Translation Softwares (“Translation Software 1” & “Translation Software 2” in this example, defined for one project X28) running on different machines residing at different locations (New-York and Paris in this example). This behavior is transparent for the user and is configured in the remoteadmin utility (see below).

In this example the Paris' Translation Server runs two instances of the “Translation Software 1” and one instance of the “Translation Software 2” at the same time.

2. Detailed Architecture of a Specific Embodiment of the Invention.

In this specific embodiment of the method, the system is also using the general principle shown in FIG. 3.

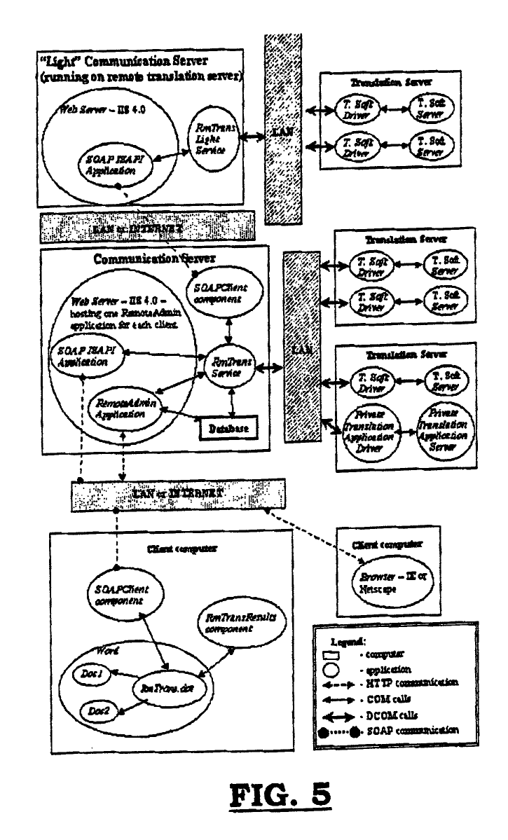

The detailed architecture of this specific embodiment of the method according to the invention is shown in FIG. 5.

Each computer using the system is running some specific modules. The modules used in each zone are:

Modules of the client zone

Modules of the communication zone

Modules of the server zone

2.1 Client Computer's Modules

Specific modules running on the user (translator) computer (3) can be (in this specific embodiment—see FIG. 5):

Internet Client software to handle the Internet protocol communication with the Communication Server (through the Internet or lan but this is transparent for the user). Such module can encrypt the data to be translated (which it gets from RmTrans Word template—see below), sends it over the Internet/lan to a server hosting a RemoteAdmin application (the “Communication Server”); it can also decrypt the answer and passes it back to RmTrans template.

In such an embodiment of the method according to the invention, the https & SOAP protocols can be used but many other protocols could be used as well.

RmTrans software as a Ms-Word template (visual basic for application)—which provides the interface between MS-Word documents and internet client and RmTransResults components (see below). It passes the Word selection and/or current sentence to the Internet Client component, to be translated and forwards the answer to the RmTransResults & to MS-Word, in order to get them displayed.

RmTransResults component—providing an interface application that displays the translation results and other information. It can be written in C++ using MFC.

The embodiments of the method according to the invention, specifically disclosed hereabove, are implemented in Ms-Word and therefore propose a Ms-word template. Adaptations can be easily made for any other word processor or application, by those skilled in the art.

The user can also use a browser interface like MSIE.

2.2 Communication Server's Modules

This specific embodiment uses a communication server. Communication Server modules handle all the communication between the client(s) and the Translation Server(s). These can also perform some work (ie: compare results returned by several servers) before returning the translation to the client. Other modules running as part of the Communication Server can be:

Remoteadmin software, a web administration software which allows the user to perform the following tasks:

Configure the database from a browser. Depending on the user rights the application shows and eventually modifies the database configuration, which governs all the translation operations.

Online translation. The application redirects all the translation requests (coming from a browser) to the RmTrans service and the displays the results in the translation panel web page.

Translation from Ms-Word. The application decrypts the requests coming from Word (through Internet Client component), redirect them to RmTrans service, encrypts the results and send them back to the client. The application can also perform a processing before returning the answer to the client (ex: each system returns a translation, the best translation only is returned to the user).

Module Load balancing: the remoteadmin allows to specify if the Translation Software should run on a specific Translation Server or if it should run on the less busy Translation Server. It can then handle load balancing.

The Remoteadmin software can suitably be written in ASP with VBScript and the database operations can suitably be made through ADO.

RmTrans service software, which has the role to provide a generic interface to the RemoteAdmin application and dispatch the DCOM calls to the particular translation drivers, according to the information it gets from RemoteAdmin applications. All the management of the Translation Servers (what servers are started, on what computers, how many instances of each etc.) is done in this component.

2.3 Translation Server Modules

In this specific embodiment of the method, translations server modules are essentially drivers to communicate with proprietary or third party Translation Software(s). The system can communicate with any software that can be queried for translations (ex: using API, or web server, etc. . . . )

drivers for the particular translation applications—which can start and stop the particular translation application, pass the data it gets from RmTrans component (through DCOM calls), in a suitable form and pack the results in the generic form requested by RmTrans component. Such modules can be written in C++ using ATL.

Translation Software—this application actually performs the translation as directed by the driver. It should allow a sort of control by another application, ideally an automation interface. A translation software is any application or web server/service that can be queried for translation.

1. Method for computer-assisted translation, by processing source language sequences by means of translation software to provide a user with (a) target language translation sequence proposal(s) for said source language sequences, to allow said user to select and/or modify a target language translation sequence proposal, and to save the pair of submitted source language sequence and selected and/or modified target language translation sequence for future use, in which a user computer is connected through a network to at least one remote translation server operating at least one translation software.

2. Method according to claim 1, in which the user computer is connected to the remote translation server(s) through an internet protocol network or a LAN network.

3. Method according to claim 2, which operates a client server model through internet.

4. Method according to claim 2, which involves a communication server.

5. Method according to claim 2, which operates a peer to peer model using a communication server.

6. Method according to claim 1, in which the user computer is connected to the remote translation server from a browser application or from a word processing application.

7. Method according to claim 1, in which the translation software(s) is/are selected from translation memory systems and/or machine translation systems and/or any other application or server that can be queried for translation.

8. Method according to claim 1, in which the translation software(s) provide further information, in addition to the target language translation sequence proposal(s).

9. Method according to claim 1, which can operates several translation softwares, which can operate several translation projects concomitantly and in which several users can connect concomitantly to one translation project.

10. Method according to claim 9, wherein said several translation softwares can be provided from a single translation server or from multiple translation servers.
